(19) United States
(12) Patent Application Publication
(10) Pub. No.: US 2014/0285994 A1
(43) Pub. Date: Sep. 25, 2014

(54) LIGHT-EMITTING BODY AND MANUFACTURING METHOD THEREOF, AND LIGHT-EMITTING DEVICE INCLUDING THE SAME

(71) Applicant: STANLEY ELECTRIC CO., LTD., Tokyo (JP)

(72) Inventor: Naoto Suzuki, Tokyo (JP)

(73) Assignee: STANLEY ELECTRIC CO., LTD., Tokyo (JP)

(21) Appl. No.: 14/218,564

(22) Filed: Mar. 18, 2014

(30) Foreign Application Priority Data
Mar. 19, 2013 (JP) 2013-056644

(51) Int. Cl. F21K 99/00

(52) U.S. Cl. CPC F21K 9/56
USPC 362/84; 362/351; 29/426.2

(57) ABSTRACT

A lighter and smaller light-emitting device (for use in a vehicle lighting unit) using a light-emitting body and a manufacturing method of the light-emitting body are provided. The light-emitting device can include a light source configured to emit light for excitation, and a light-emitting body configured to absorb excitation light to emit fluorescence light. The light-emitting body can include: a first light-transmitting member with a plate shape and having a first surface, a second surface opposite to the first surface, and an outer peripheral surface between the first surface and the second surface; a phosphor layer disposed on the outer peripheral surface of the first light-transmitting member; a second light transmitting member disposed on an outer peripheral surface of the phosphor layer; and a light-shielding member (such as a reflection film) configured to cover the first surface. In this light-emitting device, the light source can be disposed such that the excitation light therefrom can be incident on the second surface, pass through the first light-transmitting member, and reach the phosphor layer.

This application claims the priority benefit under 35 U.S.C. §119 of Japanese Patent Application No. 2013-056644 filed on Mar. 19, 2013, which is hereby incorporated in its entirety by reference.

### TECHNICAL FIELD

The presently disclosed subject matter relates to semiconductor light-emitting devices, and in particular, to a light-emitting body which utilizes light emitted from a semiconductor light-emitting element to be used for excitation of a wavelength conversion material, thereby causing the wavelength conversion material to emit wavelength converted light for illumination. The presently disclosed subject matter relates to a manufacturing method thereof, and a light-emitting device using the same.

### BACKGROUND ART

In the field of conventional vehicle lighting units, semiconductor light-emitting elements, such as LEDs, can be utilized as a light source.

One example of such a vehicle lighting unit utilizing a semiconductor light-emitting element is disclosed in Japanese Patent Application Laid-Open No. 2003-317513 (or the corresponding U.S. application laid-open publication no. 2003/0198060A1). The vehicle lighting unit can include a projection lens having a focus point on a rear side thereof, a semiconductor light-emitting element such as an LED, a spheroidal first reflecting surface having a second focus at or substantially near the semiconductor light-emitting element and a second focus at or substantially near the rear side focus point of the projection lens, a second reflecting surface extending from a front end of the first reflecting surface and inclined forward and downward, a shade, etc.

In the vehicle lighting unit, light emitted from the semiconductor light-emitting element and having a relatively high light intensity can be incident on the first reflecting surface and reflected by the same to be converged at or near the rear side focus point of the projection lens, thereby being projected forward through the projection lens. The light being incident on the second reflecting surface, on the other hand, can be reflected by the same and pass above the second focus to be projected forward through the projection lens. The thus projected light can form a predetermined light distribution pattern on a virtual vertical screen disposed in front of a vehicle body approximately 25 m away from the vehicle body.

In recent years, in order to comply with the demand for improving fuel consumption efficiency of a vehicle, a lighter and smaller lighting fixture is required.

### SUMMARY

The presently disclosed subject matter was devised in view of these and other problems and features in association with the conventional art. According to an aspect of the presently disclosed subject matter, there are provided a lighter and smaller light-emitting device using a light-emitting body and a manufacturing method of the light-emitting body.

According to another aspect of the presently disclosed subject matter, a light-emitting device can include a light source configured to emit light for excitation, and a light-emitting body configured to absorb excitation light to emit fluorescence light. The light-emitting body can include: a first light-transmitting member with a plate shape and having a first surface, a second surface opposite to the first surface, and an outer peripheral surface between the first surface and the second surface; a phosphor layer disposed on the outer peripheral surface of the first light-transmitting member; a second light transmitting member disposed on an outer peripheral surface of the phosphor layer; and a light-shielding member (such as a reflection film) configured to cover the first surface. In this light-emitting device, the light source can be disposed such that the excitation light therefrom can be incident on the second surface, pass through the first light-transmitting member, and reach the phosphor layer.

In the light-emitting device with the above configuration, the light-shielding member can cover the phosphor layer and the second light-transmitting member on the same side as the first surface.

Alternatively, in the light-emitting device with the above configuration, the phosphor layer can be exposed on a side of the first surface, and the light-shielding member can cover the first surface and the second light-transmitting member on the same side as the first surface.

According to still another aspect of the presently disclosed subject matter, a method of manufacturing a light-emitting body can include: preparing a plate light-transmitting member having a first surface and a second surface opposite to the first surface; determining shapes of individual pieces constituting the light-transmitting member; forming a groove in the first surface so that the groove can have a similar shape as at least part of the shape of the individual piece; filling the groove with a phosphor; forming a light-shielding member (such as a reflection film) on the first surface; thinning the light-transmitting member; and separating the light-transmitting member to make it to the individual pieces.

According to still another aspect of the presently disclosed subject matter, a light-emitting body can include a first light-transmitting member with a plate shape, a phosphor layer disposed on an outer peripheral surface of the first light-transmitting member, a second light-transmitting member disposed on an outer peripheral surface of the phosphor layer, and a light-shielding member (such as a reflection film) configured to cover a top surface of the first light-transmitting member.

In the light-emitting body with the above configuration, the phosphor layer can be exposed between the first light-transmitting member and the second light-transmitting member, and the light-shielding member can cover the top surface of the first light-transmitting member and a top surface of the second-light transmitting member.

According to the presently disclosed subject matter, a smaller and lighter lighting device using a light-emitting body and a manufacturing method of the light-emitting body can be provided.

### BRIEF DESCRIPTION OF DRAWINGS

These and other characteristics, features, and advantages of the presently disclosed subject matter will become clear from the following description with reference to the accompanying drawings, wherein:

FIG. 1 is a sectional view of a vehicle lighting unit that can utilizes a light-emitting body made in accordance with principles of the presently disclosed subject matter;

FIG. 2 is an enlarged sectional view illustrating the light-emitting body and the periphery thereof;

FIG. 3 is a perspective view of the light-emitting body;

FIG. 4 is a diagram illustrating the directional characteristics of the light-emitting body;

FIG. 5 is a diagram illustrating the directional characteristics of the light-emitting device;

FIG. 6 is a diagram illustrating a vehicle lighting unit in which a light-emitting device utilizing the light-emitting body is mounted;

FIG. 7 is a perspective view illustrating the vehicle lighting unit in which a light-emitting device utilizing the light-emitting body is mounted;

FIGS. 8A to 8C are a top view, a front view and a side view each illustrating the vehicle lighting unit in which a light-emitting device utilizing the light-emitting body is mounted;

FIG. 9 is a sectional view illustrating the vehicle lighting unit in which a light-emitting device utilizing the light-emitting body is mounted;

FIG. 10 is a diagram illustrating the vehicle lighting unit in which a light-emitting device utilizing the light-emitting body is mounted;

FIG. 11 is a diagram illustrating a light distribution pattern formed by the vehicle lighting unit in which a light-emitting device utilizing the light-emitting body is mounted;

FIG. 12 is an enlarged sectional view illustrating the light-emitting body and the periphery thereof;

FIG. 13 illustrates a manufacturing method of the light-emitting body according to the presently disclosed subject matter;

FIG. 14 is an enlarged sectional view illustrating a modification of the light-emitting body according to the presently disclosed subject matter and the periphery thereof; and

FIG. 15 illustrates a manufacturing method of the light-emitting body according to the modification.

### DESCRIPTION OF EXEMPLARY EMBODIMENTS

A description will now be made below to vehicle lights of the presently disclosed subject matter with reference to the accompanying drawings in accordance with exemplary embodiments.

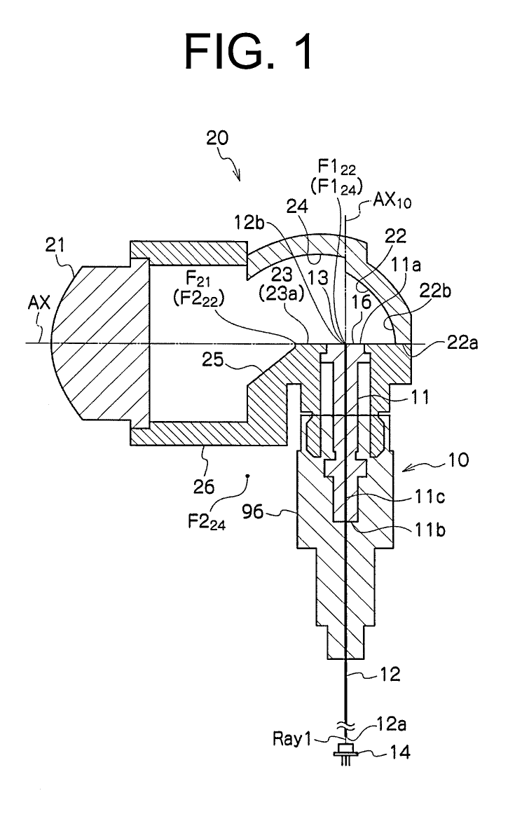

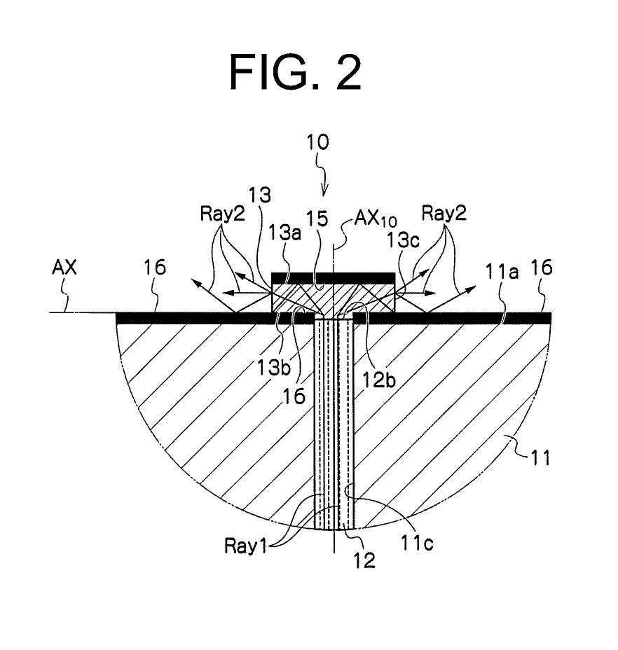

FIG. 1 is a sectional view of a vehicle lighting unit 20 that can utilizes a light-emitting body 13 made in accordance with principles of the presently disclosed subject matter when the vehicle lighting unit 20 is cut along a vertical plane including its optical axis AX. FIG. 2 is an enlarged sectional view illustrating the light-emitting body 13 and the periphery thereof.

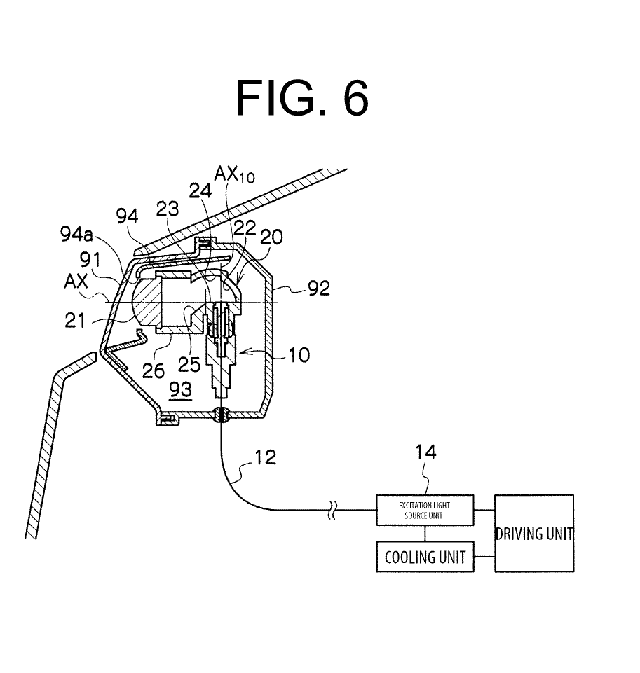

As illustrated in FIG. 1, the vehicle lighting unit 20 can include a ferrule 11, a light guide 12, a light-emitting body 13, a light source 14 for emitting excitation light (for example, including an excitation light source unit, a cooling unit, a driving unit, etc. as illustrated in FIG. 6), etc.

The ferrule 11 can have a cylindrical shape having a top surface 11a and a lower surface 11b, and be a member configured to hold the light guide 12. The ferrule 11 can be formed with a through hole 11c for light guide to communicate the upper surface 11a the lower surface 11b. The light guide 12 at its light emission end can be inserted through the through hole 11c to be held by the ferrule 11. The light guide 12 can include a light emission surface 12b that is flush with the upper surface 11a of the ferrule 11 by polishing the top surface 11a of the ferrule 11, for example.

The ferrule 11 can be made of any material as long as it can hold the light guide 12, the material including stainless steel, nickel, zirconia, other metals, resins, and glass.

The top surface 11a of the ferrule 11 can be covered with a circular reflection member 16 as illustrated in FIG. 2. The reflection member 16 can be any member that can reflect light emitted from the light-emitting body 13 toward the light-emitting body 13. For example, the reflection member 16 can be a reflection layer formed by vapor-depositing aluminum or silver, or by plating, or a reflection film formed from a dielectric multi-layered film. Further, the reflection member 16 can be a thin plate reflection member adhered to the top surface 11a of the ferrule 11 (region of the top surface 11a other than the light emission surface 12b of the light guide 12), or a reflection surface formed by polishing the top surface 11a of the ferrule 11 if the ferrule 11 is made of a metal.

The light guide 12 can be configured to guide excitation light from the excitation light source 14 to illuminate the light-emitting body 13 with the light. The light guide 12 can be an optical fiber having a center core (for example, core diameter of 0.2 mm), and a cladding layer covering the periphery of the core (both of them are not illustrated in the drawings). The refractive index of the core can be made higher than that of the cladding layer. Accordingly, the excitation light incident on one end surface of the light guide, or the light incident surface 12a, can be guided by the light guide 12 while the total internal reflection at the boundary between the core and the cladding layer to confine the light within the core is utilized. The excitation light can be then guided to the other end, or the light emission surface 12b to project therethrough.

The light guide 12 can be any fiber as long as the excitation light from the light source 14 can be guided, and may be a single fiber or a multi-fiber. Furthermore, the light guide 12 can be a single mode fiber or a multi-mode fiber. In addition, the light guide 12 can be formed from any material, such as quartz glass, a plastic material, etc. The light guide 12 can be preferably a single fiber and a multi-mode fiber.

The light incident surface 12a of the light guide 12 can be disposed near and in front of the excitation light source 14. In order to cause the excitation light from the excitation light source 14 to be effectively incident on the light incident surface 12a of the light guide 12, a condenser lens (not shown) can be provided between the light incident surface 12a and the excitation light source 14.

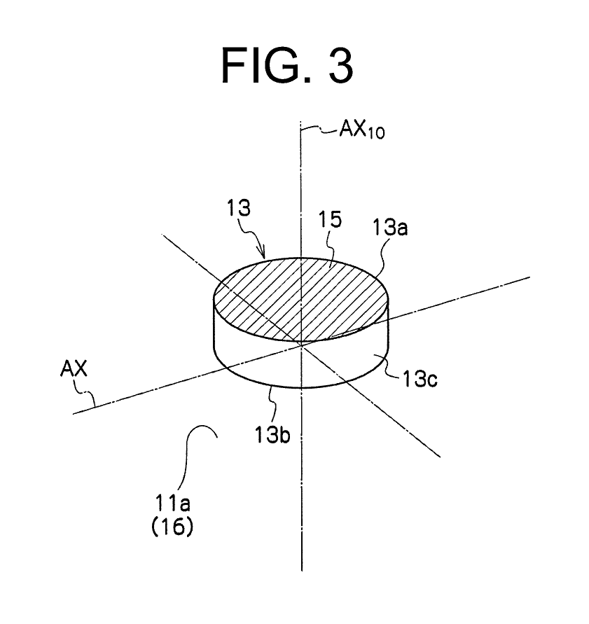

FIG. 3 is a perspective view of the light-emitting body 13.

As illustrated in FIG. 3, the light-emitting body 13 can include a phosphor that can absorb the excitation light (be excited by the excitation light) and emit light with a predetermined wavelength region by wavelength conversion. The light-emitting body 13 can have a shape, for example, a cylindrical shape extending in a direction perpendicular to the top surface 11a of the ferrule 11. The light-emitting body 13 can include a circular lower surface 13b (or a first surface), a circular top surface 13a (or a second surface) opposite to the lower surface 13b, and a ring-shaped peripheral surface 13c (side surface). The size thereof can be 0.2 mm in thickness and 1.0 mm in diameter, for example.

The light-emitting body 13 can be a phosphor sintered by such as a cylindrical YAG plate extending in the direction perpendicular to the top surface 11a of the circular ferrule 11. In this light-emitting body 13, the optical path length from the light emission surface 12b of the light guide 12 to the peripheral surface 13c of the light-emitting body 13 can be made uniform in the entire periphery. This configuration can suppress or prevent the color unevenness and luminance unevenness at the peripheral surface 13c of the light-emitting body 13.

The light-emitting body 13 can be a polygonal or other shaped column shape extending in the direction perpendicular to the top surface 11a of the ferrule 11. The light-emitting body 13 can contain, for example, a yellow phosphor in an adjusted concentration, thereby regulating the color of the emission light to satisfy the white range in the CIE chromaticity diagram in accordance with a certain law.

The top surface 13a of the light-emitting body 13 can be covered with a light-shielding member 15. The light-shielding member 15 can be formed from any member as long as the member can shield light emitted from the light-emitting body 13 and directed to and projected through the top surface 13a. For example, the light-shielding member 15 can be a black coating applied to the top surface 13a of the light-emitting body 13, a reflection layer formed by vapor-depositing aluminum, silver, or the like onto the top surface 13a of the light-emitting body 13, or a thin plate reflection member or a diffusion-reflection member made of a white resin adhered to the top surface 13a of the light-emitting body 13. The light-shielding member 15 can be a dielectric multi-layered film optimized at the wavelength of the excitation light source 14.

When the light-shielding member 15 is formed from a reflection layer or a reflection surface such as a reflection plate, the light emitted from the light-emitting body 13 and directed toward and projected through the top surface 13a of the light-emitting body 13 can be reflected by the light-shielding member 15 to be returned back to the light-emitting body 13. Therefore, the light extraction efficiency of light emitted from the peripheral surface 13c of the light-emitting body 13 can be enhanced.

As illustrated in FIG. 2, the lower surface 13b of the light-emitting body 13 can be bonded to the top surface 11a (reflection member 16) of the ferrule 11 around the through hole 11c for light guide so that the lower surface 13b can cover the through hole 11c (the light emission surface 12c of the light guide 12). Namely, the light-emitting body 13 can be disposed on the top surface 11a of the ferrule 11 at its center. Further, as illustrated in FIG. 2, the center of the lower surface 13b of the light-emitting body 13 can coincident with the center of the through hole 11c for the light guide (or a center of the light emission surface 12b of the light guide 12). Accordingly, the lower surface 13b of the light-emitting body 13 can be covered with the reflection member 16 other than the region facing the through hole 11c (light emission surface 121b o the life guide). Accordingly, the light emitted from the light-emitting body 13 and directed to and projected through the lower surface 13b of the light-emitting body 13 can be reflected by the reflection member 16 and returned to the light-emitting body 13. This can improve the light extraction efficiency.

The light emission surface 12b of the light guide 12 can be flush with the top surface 11a of the ferrule 11. Accordingly, the lower surface 13b of the light-emitting body 13 can be in intimate contact with the light emission surface 12b of the light guide 12. Note that a slight gap between the lower surface 13b of the light-emitting body 13 and the light emission surface 12b of the light guide 12 may be present.

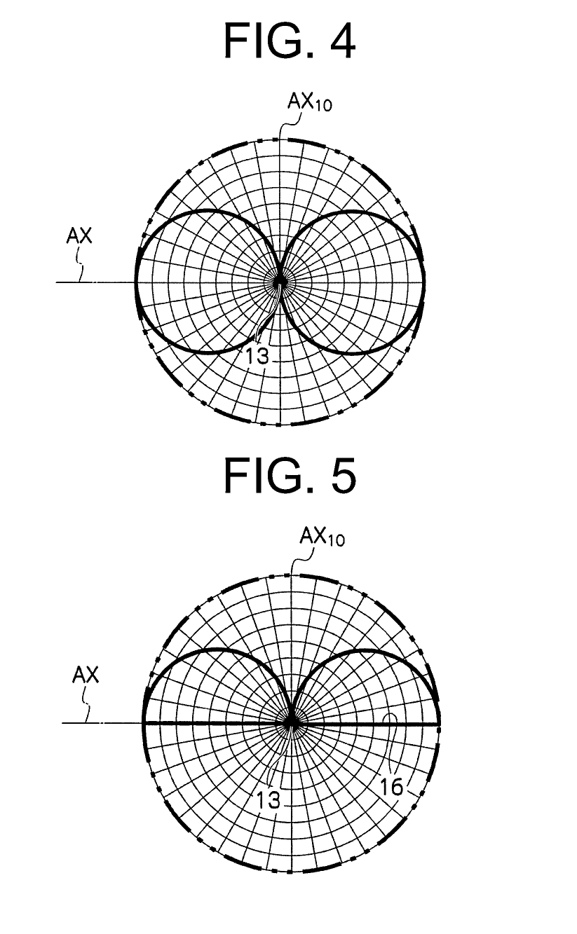

The reflection member 16 (the top surface 11a of the ferrule 11) can have a larger diameter than the light-emitting body 13 and extend outside than the diameter of the lower surface 13b of the light-emitting body 13. Namely, the reflection member 16 can be disposed around the lower surface 13b of the light-emitting body 13. Accordingly, the light emitted from the light-emitting body 13 through its entire peripheral surface 13c downward can be reflected by the reflection member 16 upward. With this configuration, the light-emitting device 10 can emit light with half bi-directional pattern as shown in FIG. 5 which is half of the bi-directional pattern as shown in FIG. 4.

The excitation light source 14 can be a light source configured to generate excitation light, and preferably be a semiconductor light-emitting element such as an LED, an LD, or the like. In view of the light utilization efficiency, an LD (laser diode) is desired. In the present exemplary embodiment, an LD having an emission wavelength of 400 nm to 450 nm is used as the excitation light source 14. Note that the excitation light source 14 can be fixed to an appropriate position other than the vehicle lighting unit 20 (a body frame or a housing fixed to a body frame) with a screw or other known means.

In the light-emitting device 10 with the above configuration, as illustrated in FIGS. 1 and 2, the excitation light Ray1 from the excitation light source 14 can enter the light incident surface 12a of the light guide 12 and be guided through the light guide 12 to the light emission surface 12b to exit through the light emission surface 12b. The light can illuminate the light-emitting body 13.

The light-emitting body 13 receiving the excitation light from the light source 14 can emit light due to excitation by the excitation light from the light source 14. The light from the light-emitting body 13 and part of excitation light not absorbed by the light-emitting body 13 and passing through the light-emitting body 13 can be mixed to form white light Ray2.

The white light Ray2 generated by the light-emitting body 13 can be emitted directly through the entire peripheral surface 13c of the light-emitting body 13 or be reflected by the light-shielding member 15 and/or the reflection member 16 and then emitted through the entire peripheral surface 13c.

FIG. 4 is a diagram illustrating the directional characteristics of the light-emitting body 13. In FIG. 4, the solid line represents the directional characteristics (bi-directional pattern) in a cross section of the light-emitting body 13 cut along a vertical plane including an optical axis AX₁₀ (a center axis of the through hole 11c for light guide) while the dashed-two dotted line represents the directional characteristics of the light-emitting body 13 when it is viewed from the top surface 13a side.

Since the top surface 13a of the light-emitting body 13 can be covered with the light-shielding member 15, the directional characteristics in the cross section (cross section of the peripheral surface 13c of the light-emitting body 13) of the light-emitting body 13 cut along a vertical plane including an optical axis AX₁₀ (a center axis of the through hole 11c for light guide) can be the bi-directional pattern in a vertically symmetric shape as illustrated with the solid line in FIG. 4. (Meaning that the intensity within the horizontal plane including its optical axis AX is maximum.)

On the other hand, since the peripheral surface 13c of the light-emitting body 13 is a ring-shaped surface, the directional characteristics of the light-emitting body 13 when viewed from its top surface 13a can be a radially spread distribution around the light-emitting body 13 as a center, as illustrated with the dashed-two dotted line in FIG. 4.

The white light Ray2 emitted downward from the entire peripheral surface 13c of the light-emitting body 13 can be reflected by the reflection member 16 disposed around the lower surface 13b of the light-emitting body 13 to be returned upward.

As a result, the directional characteristics of the light-emitting device 10 in a cross section thereof cut along the vertical plane including the optical axis AX₁₀ can be a half of the bi-directional pattern as illustrated with solid line in FIG. 5. Also in this case, the intensity within the horizontal plane including its optical axis AX can be maximum.

On the other hand, since the peripheral surface 13c of the light-emitting body 13 is a ring-shaped surface, the directional characteristics of the light-emitting device 10 when viewed from its top surface can be a radially spread distribution around the light-emitting body 13 as a center, as illustrated with the dashed-two dotted line in FIG. 5.

As described, FIG. 5 is a diagram illustrating the directional characteristics of the light-emitting device 10. In FIG. 5, the solid line represents the directional characteristics (half of bi-directional pattern) in the cross section of the light-emitting device 10 cut along the vertical plane including the optical axis AX₁₀ while the dashed-two dotted line represents the directional characteristics of the light-emitting device 10 when it is viewed from the top surface.

As described above, the directional characteristics of the light-emitting body 10 can be a three-dimensional distribution obtained by rotating the arcs shown by the solid line in FIG. 5 around the optical axis AX₁₀ by 360 degrees. Specifically, the intensity can be maximum within the horizontal plane including the optical axis AX thereof and be reduced as the position is farther away from the horizontal plane. This three-dimensional pattern can be substantially coincident with a specific light distribution pattern, such as a low-beam light distribution pattern.

As described, the light-emitting device 10 of the present exemplary embodiment can include the light-shielding member 15 and the reflection member 16 disposed around the lower surface 13b of the light-emitting body 13. With this configuration, the light emitted from the entire peripheral surface 13c of the light-emitting body 13 (with the bi-directional pattern) can be reflected by these members to produce light with a half of bi-directional pattern. Accordingly, this can facilitate the thinned configuration of the light-emitting device in the vertical direction of the vehicle lighting unit.

A description will now be given of a vehicle lighting unit 20 utilizing the light-emitting device 10 with the above configuration.

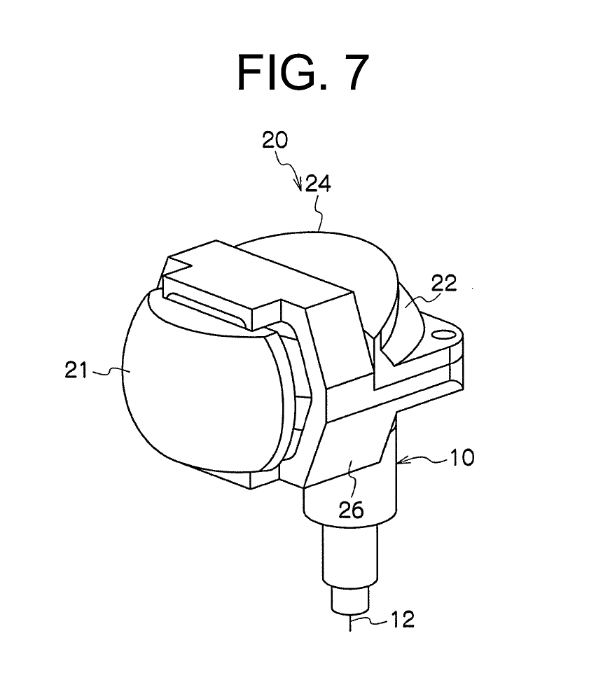

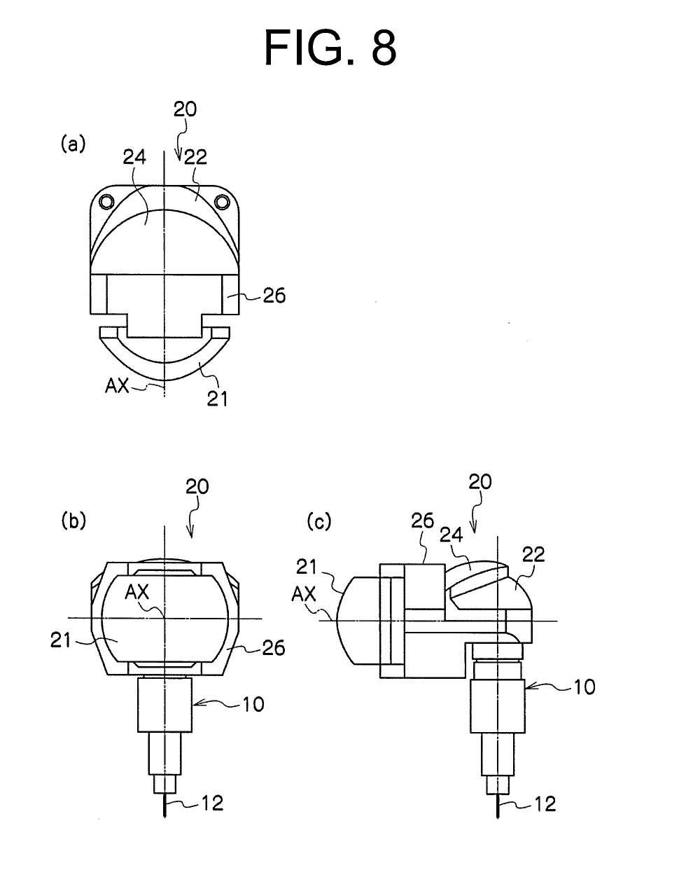

The vehicle lighting unit 20 of the present exemplary embodiment can form a vehicle headlight to be mounted on right and left front portions of a vehicle body such as an automobile. FIG. 6 is a diagram illustrating the vehicle lighting unit 20 utilizing the light-emitting device 10. FIG. 7 is a perspective view illustrating the vehicle lighting unit 20. FIGS. 8A, 8B, and 8C are a top view, a front view and a side view each illustrating the vehicle lighting unit 20.

As illustrated in FIG. 6, the vehicle lighting unit 20 can be housed within a lighting chamber 93 defined by a front lens 91 and a housing 92. The vehicle lighting unit 20 can be coupled to a known aiming mechanism (not shown) so that the optical axis can be adjusted properly.

As illustrated in FIGS. 1 and 6 to 8C, the vehicle lighting unit 20 can be a projector type vehicle lighting unit configured to form a low-beam light distribution pattern. The vehicle lighting unit 20 can include a projection lens 21, the light-emitting device 10, a main reflector 22, a shade 23, a first sub-reflector 24, a second sub-reflector 25, a mirror shade 26 also serving as a holding member, etc.

As illustrated in FIG. 1, the ferrule 1 that constitutes the light-emitting device 10 can be detachably fixed by fixing a connector 96 to the mirror shade or holding member 26 by screwing or by engaging the connector 96 to the mirror shade or holding member 26. Examples of the connector 96 may include an FC connector in accordance with JIS standard, an SC connector, and other known connectors.

As illustrated in FIG. 1, the projection lens 21 can be held by the aluminum-made holding member 26 to be disposed on the optical axis AX extending in the front-to-rear direction of the vehicle body.

The projection lens 21 can be a plano-convex aspherical projection lens having a convex surface on its front side and a plane surface on its rear side. As illustrated in FIG. 6, the projection lens 21 can be exposed through an opening 94a formed in an extension 94 while its outer peripheral edge can be covered with the extension 94.

As illustrated in FIG. 1, the light-emitting device 10 can be fixed to the holding member 26 while the state of the light-emitting device 10 is maintained in which the reflection member 16 is located within an upward horizontal plane including the optical axis AX. In this configuration, the optical axis AX can pass through the center of the light-emitting body 13. (See FIGS. 3 and 4.) Accordingly, the directional characteristics of the light-emitting device 10 can be a half of the bi-directional pattern as illustrated with solid line in FIG. 5 wherein the intensity within the horizontal plane including its optical axis AX can be maximum.

As illustrated in FIG. 1, the main reflector 22 can be a spheroidal reflecting surface (or similar free curved surface) having a first focus F1₂₂ at or substantially near the light-emitting body 13 and a second focus F2₂₂ at or substantially near the rear side focus F₂₁ of the projection lens 21.

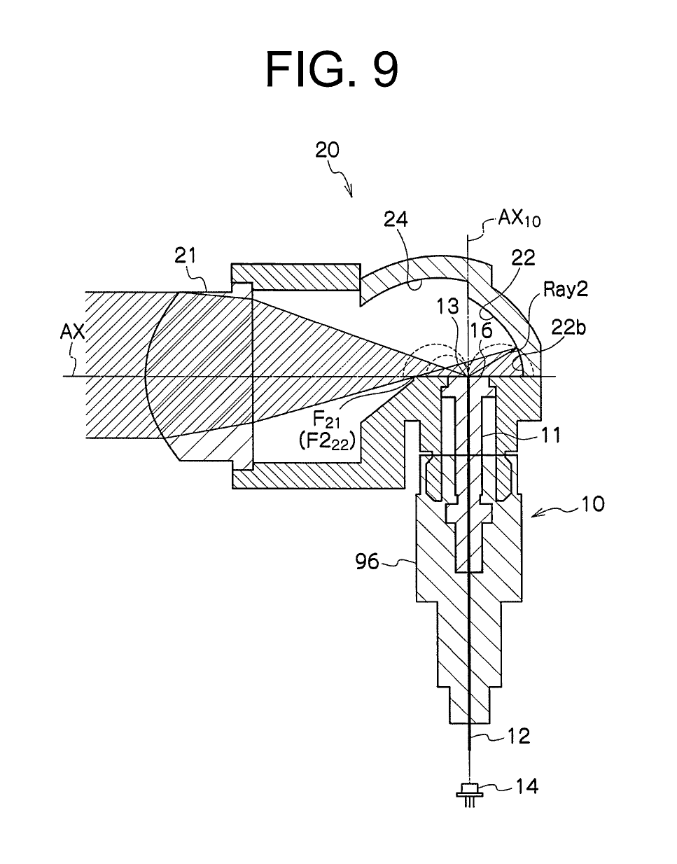

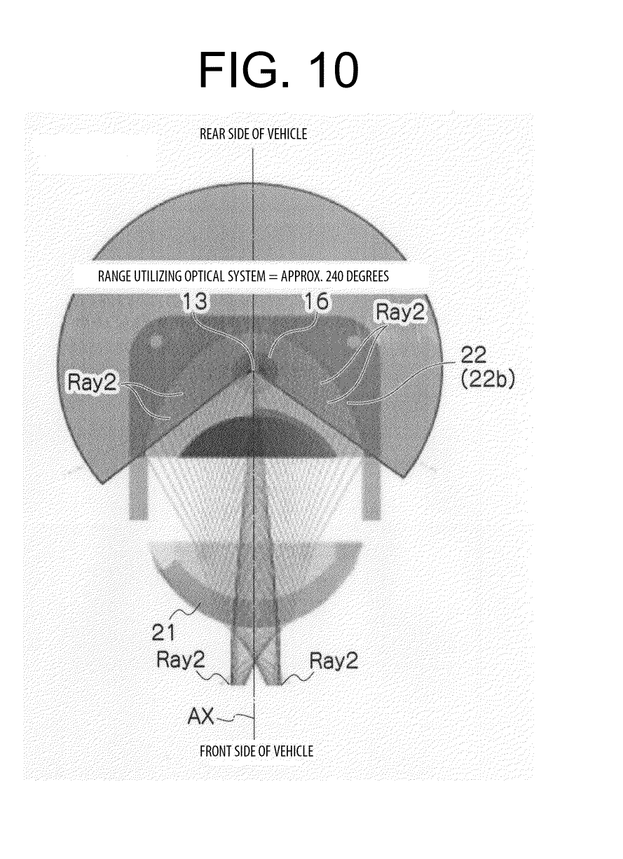

FIG. 9 is a vertical sectional view illustrating the vehicle lighting unit 20 cut along a vertical plane including its optical axis AX (also illustrating optical paths). FIG. 10 is a horizontal sectional view illustrating the vehicle lighting unit 20 cut along a horizontal plane including its optical axis AX (also illustrating optical paths).

The main reflector 22 can be disposed to cover the light-emitting body 13 (the peripheral surface 13c) so that the light from the light-emitting device 10, i.e., the light having a three-dimensional distribution obtained by rotating the arcs shown by the solid line in FIG. 5 around the optical axis AX₁₀ by 120 degrees leftward and rightward (total 240 degrees) can be incident on the main reflector 22.

Specifically, the main reflector 22 can cover the light-emitting body 13 (the peripheral surface 13c) by surrounding the light-emitting body 13, for example, a range from left side to right side by 120 degrees with respect to the optical axis AX extending in the rear direction. (See FIGS. 1, 8A, 8C, and 10.) The main reflector 22 can have a lower edge 22a positioned on the horizontal plane including the optical axis AX. (See FIG. 1.)

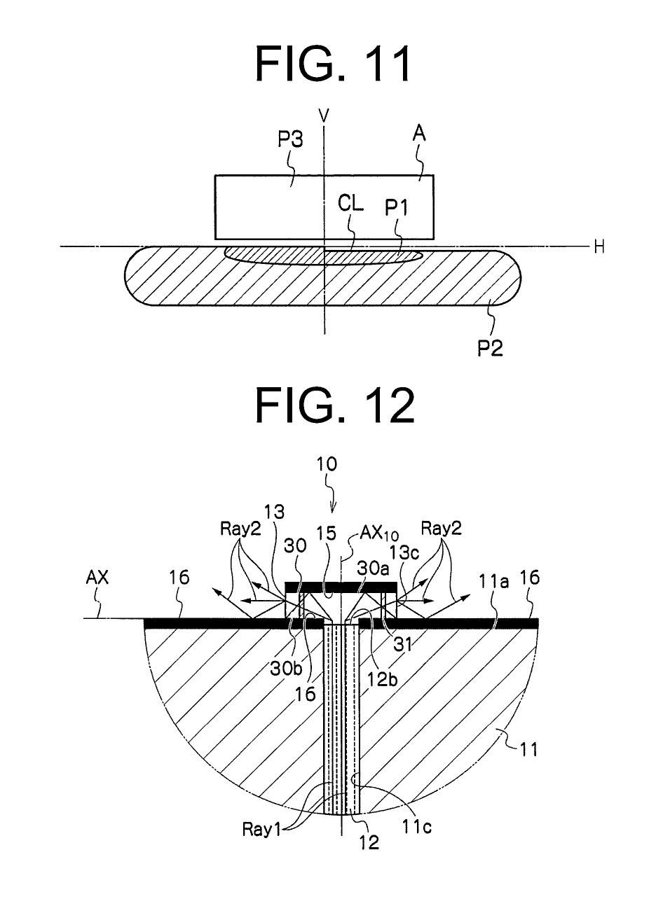

Accordingly, the light Ray2 with a relatively high light intensity emitted from the peripheral surface 13c of the light-emitting body 13 (in the range of 120 degrees leftward and rightward with respect to the optical axis AX (240 degrees in total)) can be incident on the region 22b of the main reflector 22 near the horizontal plane including the optical axis AX. (See FIGS. 9 and 10.) Here, the light Ray2 can be, for example, light within a half-value angle at which the light intensity is 50% or the half of the bi-directional pattern. Since the main reflector 22 (the region 22b) can have an ellipsoidal cross section in the vertical direction, the light Ray2 with the relatively high light intensity can be reflected by the main reflector 22 (the region 22b) to be condensed at the second focus F2₂₂ and substantially collimated by the projection lens 21 (see FIG. 9) when viewed within the vertical plane. On the other hand, since the main reflector 22 (the region 22b) does not have an ellipsoidal cross section in the horizontal direction, the light Ray2 can be reflected by the main reflector 22 (the region 22b) and be projected by the projection lens 21 to intersect with each other and be diffused in the horizontal direction (see FIG. 10) when viewed within the horizontal plane. With this configuration, a partial light distribution pattern P1 with high illuminance (high illuminance region) horizontally long and vertically narrow shape can be formed as illustrated in FIG. 11. FIG. 11 is a diagram illustrating a light distribution pattern formed by the vehicle lighting unit 20 including the partial light distribution pattern P1.

It should be noted that the main reflector 22 is not specifically limited to the shape of ranging from 120 degrees left to 120 degrees right (240 degrees in total) but may be formed to cover the light-emitting body 13 above and around the same with an appropriate coverage.

As illustrated in FIG. 1, the shade 23 can include a mirror surface 23a extending from the rear side focus F₂₁ of the projection lens 21 toward the light-emitting device 10 (light-emitting body 13). The front end of the shade can be curved inwardly along the rear side focal plane of the projection lens 21. The light incident on the mirror surface 23a and reflected upward can enter the projection lens 21 to be refracted and directed to road surface. Specifically, the light to be incident on the mirror surface 23a would be directed above the cut-off line of the desired light distribution pattern if the mirror surface 23a is not provided. However, since the vehicle lighting unit 20 can include the mirror surface 23a, the light can be directed by the mirror surface 23a to be overlaid on the desired light distribution pattern below the cut-off line. Accordingly, as illustrated in FIG. 11, the desired low-beam light distribution pattern P1 can be formed with high luminance region as well as clear cut-off line CL at its upper edge.

The first sub-reflector 24 can be a spheroidal reflecting surface (or similar free curved surface) having a first focus F1₂₄ at or substantially near the light-emitting body 13 and a second focus F2₂₄ at a predetermined position below the second sub-reflector 25.

The first sub-reflector 24 can be disposed between the projection lens 21 and the main reflector 22 while extending from the front edge of the main reflector 22 toward the projection lens 21 so that the light emitted from the light-emitting device 10 and directed upward and forward (with the half of the bi-directional pattern) can be incident on the first sub-reflector 24. The first sub-reflector 24 can have its front end with a length not to hinder the light reflected by the main reflector 22 and be incident on the projection lens 21.

The main reflector 22 and the first sub-reflector 24 can be formed as a single component by integrally molding a reflector base member with a metal mold and subjecting it to a mirror finishing such as aluminum deposition. With this configuration, when compared with the case where these reflectors are formed as separate components, the reduction in number of parts, simplification of assembly step of these reflectors, the higher assembly accuracy (reduced assembly error), etc. can be achieved. As a matter of course, they may be separate members.

The second sub-reflector 25 can be disposed between the projection lens 21 and the rear side focus F₂₁ thereof so that the light reflected by the first sub-reflector 24 and directed to be condensed at the second focus F2₂₄ can be incident thereon.

In the vehicle lighting unit 20 with the above configuration, the light Ray 2 with a relatively high intensity out of the light emitting from the light-emitting device 10 (the light within a half-value angle at which the light intensity is 50% (or the half of the bi-directional pattern)) can be incident on the region 22b of the main reflector 22 near the horizontal plane including the optical axis AX. (See FIGS. 9 and 10.) Since the main reflector 22 (the region 22b) can have the ellipsoidal cross section in the vertical direction, the light Ray2 with the relatively high light intensity can be reflected by the main reflector 22 (the region 22b) to be condensed at the second focus F2₂₂ and substantially collimated by the projection lens 21 (see FIG. 9) when viewed within the vertical plane. On the other hand, since the main reflector 22 (the region 22b) does not have an ellipsoidal cross section in the horizontal direction, the light Ray2 can be reflected by the main reflector 22 (the region 22b) and be projected by the projection lens 21 to intersect with each other and be diffused in the horizontal direction (see FIG. 10) when viewed within the horizontal plane. Accordingly, a partial light distribution pattern P1 with high illuminance (high illuminance region) horizontally long and vertically narrow shape can be formed as illustrated in FIG. 11. On the other hand, the light emitted from the light-emitting device 10 and being incident on the main reflector 22 at the region other than the region 22b (the light with a relatively low light intensity or the light out of the range of the half-value angle at which the light intensity is 50%, for example) can be reflected by the main reflector 22 at the other region and projected to form a wide partial light distribution pattern P2 on a virtual vertical screen (assumed to be disposed in front of a vehicle body about 25 m away therefrom), as illustrated in FIG. 11.

Accordingly, the combined light distribution pattern (low beam light distribution pattern) can be formed by the partial light distribution pattern P1 with high illuminance and the partial light distribution pattern P2. The resulting combined light distribution pattern can be an excellent far-distance visibility.

The light emitted from the light-emitting device 10 and being incident on the first sub-reflector 24 can be reflected by the first sub-reflector 24 and then the second sub-reflector 25 to pass through the projection lens 21. The light can be directed upward by, for example, 2 degrees to 4 degrees with respect to the horizontal plane. This light can form an over-head sign light distribution pattern P3 in an over-head sign region A on the virtual vertical screen for illuminating any over-head traffic signs.

Note that the vehicle lighting unit 20 can be adjusted in optical axis by a known aiming mechanism (not shown) provided thereto in order to illuminate desired regions with the respective light distribution patterns P1 to P3.

As described, the vehicle lighting unit 20 of the present exemplary embodiment can be configured such that the light within a half-value angle at which the light intensity is 50% (or the half of the bi-directional pattern) with a relatively high light intensity emitted from the peripheral surface 13c of the light-emitting device 10 can be incident not on the region of the main reflector 22 on the optical axis AX₁₀ but on the region 22b near the horizontal plane including the optical axis AX. Accordingly, the vertically thin vehicle lighting unit 20 can be provided.

A description will now be given of the detailed description for the configuration of the light-emitting body 13 and the manufacturing method thereof. The light-emitting body 13 can include a phosphor (wavelength conversion material) that can absorb excitation light to wavelength convert the light to emit light with a predetermined wavelength. The light-emitting body 13 can have a columnar shape with a circle or polygon horizontal cross section.

Therefore, the light-emitting body 13 can have the upper surface 13a, the lower surface 13b, and the peripheral surface 13c.

It is considered to obtain the light-emitting body 13 with the above configuration by cutting a plate phosphor (YAG or the like) after sintered to have a predetermined shape. However, in this case, there would arise a problem in that excitation light and fluorescent light may be scattered within the light-emitting body 13 and part of the light may be confined within the body 13. The thus confined light may be finally changed to heat energy within the light-emitting body 13, resulting in deterioration of light conversion efficiency of the phosphor due to temperature extinction.

To cope with this problem, the light-emitting body 13 can be prepared by preparing a plate light-transmitting body 30 with a desired plane shape, forming a phosphor layer 31 around the light-transmitting body 39, and forming a light-shielding member 15 on the top surface of the light-transmitting body 30, as illustrated in FIG. 12. With the light-emitting body 13 having the above configuration, excitation light and fluorescent light can be prevented from being scattered and confined thereinside, resulting in improvement of the light emission efficiency.

In FIG. 12, the light-emitting body 13 can have a disk shape when viewed from above. The top surface 13a can be covered with the light-shielding member 15. The light-transmitting body 30 can be composed of an inner light-transmitting body 30a and an outer light-transmitting body 30b. The phosphor layer 31 can be formed between the inner light-transmitting body 30a and the outer light-transmitting body 30b.

The lower surface 13b of the light-emitting body 13 can be a lower surface of the inner light-transmitting body 30a, so that it can face the light emission surface 12b of the light guide 12. The excitation light exiting from the light emission surface 12b of the light guide 12 can be guided through the inner light-transmitting body 30a to be incident on the inner peripheral surface of the phosphor layer 31 to excite the phosphor included in the phosphor layer 31. The fluorescent light emitted from the phosphor layer and the excitation light passing through the phosphor layer without involved in excitation can be mixed to be projected to outside of the light-emitting body 13 as white light. This white light can be optically utilized by reflection of the main reflector 22 and the light.

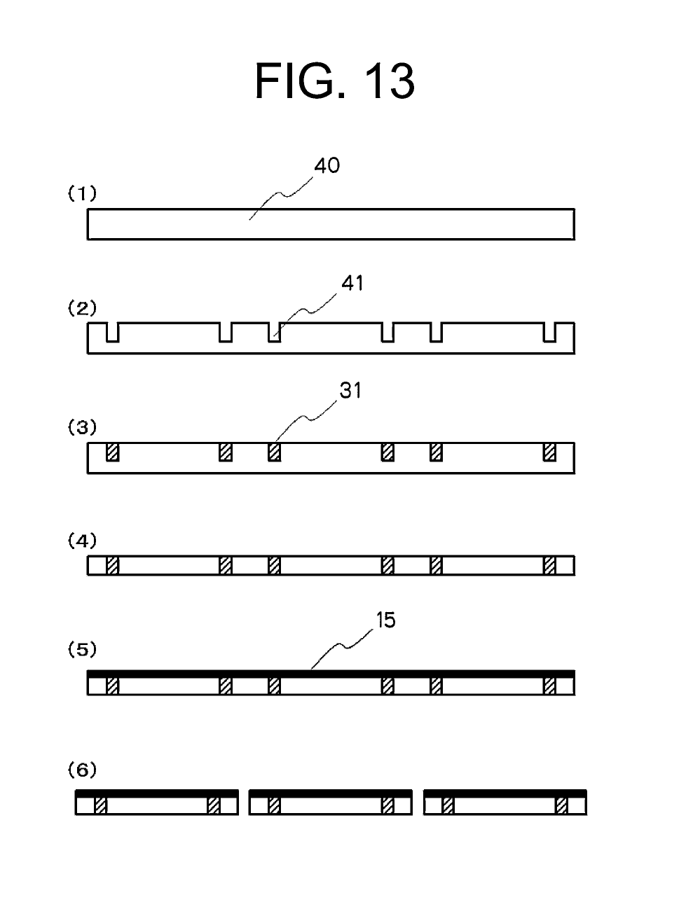

FIG. 13 illustrates a manufacturing method of the light-emitting body 13 according to the presently disclosed subject matter.

First, a light-transmitting plate 40 can be prepared ((1) in FIG. 13). The light-transmitting plate 40 can desirably be a material having a light transmittance not lower than 90% in a visible wavelength range, and may be borosilicate glass, quartz glass, or the like, for example.

Then, grooves 41 can be formed in the light-transmitting plate 40 ((2) in FIG. 13) by any appropriate known method including a half-dicing using a dicer, a dry etching method, a blasting treatment, or the like. The grooves 41 can be formed in a circular shape or the like when viewed from above, corresponding to the shape of the light-emitting body 13. The grooves 41 can have a depth corresponding to at least the height of the light-emitting body 13 or more, for example, 100 μm to 400 μm, and a width of, for example, 50 μm to 500 μm.

Then the grooves 41 can be filled with a phosphor to form the phosphor layer 31 ((3) in FIG. 13). In the present exemplary embodiment, the phosphor layer 31 can include a phosphor powder and a binder material. The raw material phosphor can be appropriately selected depending on the wavelength of the excitation light, the wavelength of emitted fluorescent light, etc. Examples of the phosphor used when a laser diode that emits light at a wavelength of around 450 nm is used as an excitation light source may include LuAG:Ce, YAG:Ce, CASN:Eu, and the like. These phosphors can be used alone or in combination of two or more in a desired mixing ratio to adjust its chromaticity. Examples of the binder material used may include various resin materials, such as an epoxy resin and a silicone resin, and low-melting point glass materials, such as a phosphate glass material.

If a resin is used as the binder material, the resin can be mixed with a phosphor in a predetermined amount ratio in advance, and stirred and defoamed (degassed), and the powdery phosphor can be uniformly dispersed in the resin. Then, the prepared phosphor containing resin can be filled into the grooves by dispensing or printing, etc. After that, the entire product can be heated under common curing conditions for the resin for a predetermined time for curing of the resin, thereby completing the phosphor layer.

If a glass material used as the binder material, a glass powder can be mixed with a phosphor in a predetermined amount ratio in advance, and the phosphor can be uniformly dispersed with the aid of a mortar. Then, the grooves can be filled with the prepared phosphor containing glass material using a squeezee or the like. After that, the entire product can be heated under melting conditions for the glass powder, thereby completing the phosphor layer (phosphor containing glass layer).

After the phosphor layer 31 was formed, the entire light-transmitting plate 40 can be polished ((4) in FIG. 13) by any known polishing techniques to have a desired thickness. In this case, one or both sides of the light-transmitting plate 40 can be polished. Furthermore, the polished surface may be roughened by adjusting a particle size of the used polishing agent (powder). If the light-shielding member 15 is formed by deposition or the like, the surface is preferably polished to be smoothed.

Then, the light-shielding member 15 can be provided on the surface of the light-transmitting plate 40 ((5) in FIG. 13). The light-shielding member 15 can be composed of a black coating, a high reflective metal film, a plate-shaped light-shielding or reflection member adhered thereto, or a dielectric multi-layered film, for example. The light-shielding member 15 being a reflective film or a dielectric multi-layered film can be formed by any known technique, including sputtering, chemical vapor deposition, physical deposition, or the like. Examples of materials used therefor may include silver, a silver alloy, aluminum, and rhodium. When the member is provided to the surface of the light-transmitting plate, an adhesion layer such as Al₂O₃ or SiO₂ may be interposed therebetween. After the member (light-shielding member or reflection member) is formed, a protective layer such as Al₂O₃ or SiO₂ may be formed thereover. In particular, when silver or a silver alloy is used as the reflection film, the provision of the protective film can prevent the silver or silver alloy film from being sulfurized.

Then, the light-transmitting plate 40 can be cut at positions outside the grooves corresponding to the respective light-emitting bodies 13 to obtain individual pieces of the light-emitting bodies 13 ((6) in FIG. 13) by any known techniques for cutting, such as a laser dicing or the like.

The step of polishing the light-transmitting plate and the step of providing the light-shielding member may be performed in the reverse order.

A description will be given of a modification of the light-emitting body 13.

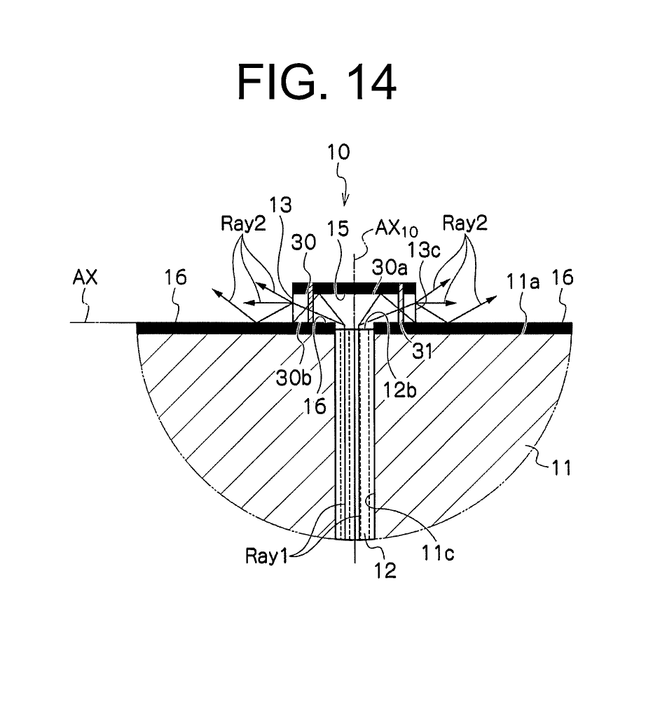

FIG. 14 is an enlarged sectional view illustrating the modification of the light-emitting body 13 according to the presently disclosed subject matter. The light-emitting body 13 of the modification can be different from that illustrated in FIG. 12 and the like in that the phosphor layer 31 is not covered with the light-shielding member 15 such that the phosphor layer 31 can be exposed in the top surface 13a of the light-emitting body 13. In this modification, it is not necessary to flatten (smooth) the exposed part of the phosphor layer 31 in the top surface 13a of the light-emitting body 13 for deposition, meaning the manufacturing method can be simplified.

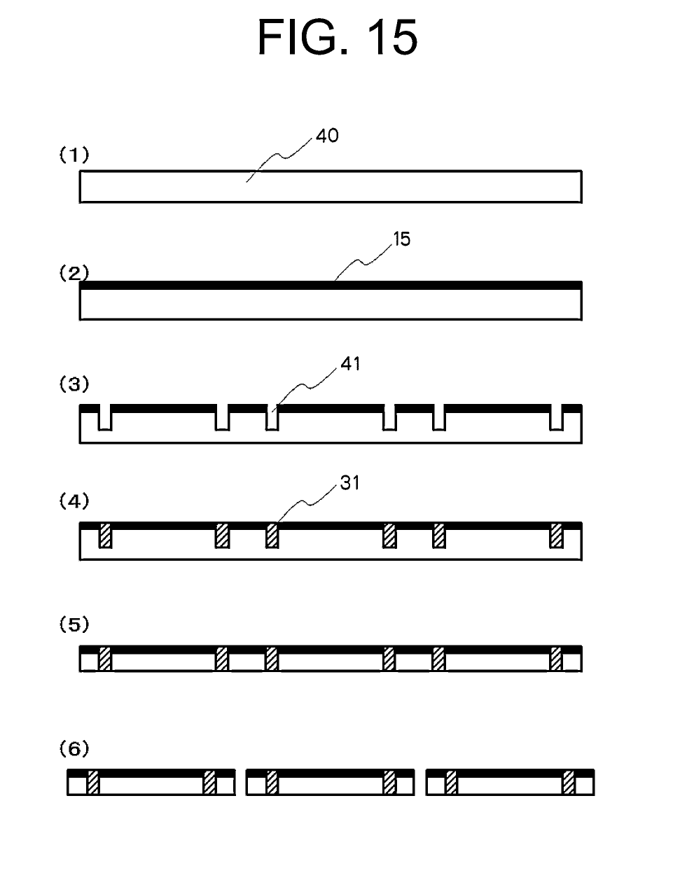

FIG. 15 illustrates the manufacturing method of the light-emitting body 13 according to the modification.

First, a light-transmitting plate 40 can be prepared ((1) in FIG. 15). The light-transmitting plate 40 can desirably be a material having a light transmittance not lower than 90% in a visible wavelength range, and may be borosilicate glass, quartz glass, or the like, for example.

Then, the light-shielding member 15 can be provided on the surface of the light-transmitting plate 40 ((2) in FIG. 15). The light-shielding member 15 can be composed of a black coating, a high reflective metal film, a plate-shaped light-shielding or reflection member adhered thereto, or a dielectric multi-layered film, for example. The light-shielding member 15 being a reflective film or a dielectric multi-layered film can be formed by any known technique, including sputtering, chemical vapor deposition, physical deposition, or the like. Examples of materials used therefor may include silver, a silver alloy, aluminum, and rhodium. When the member is provided to the surface of the light-transmitting plate, an adhesion layer such as Al₂O₃ or SiO₂ may be interposed therebetween. After the member (light-shielding member or reflection member) is formed, a protective layer such as Al₂O₃ or SiO₂ may be formed thereover. In particular, when silver or a silver alloy is used as the reflection film, the provision of the protective film can prevent the silver or silver alloy film from being sulfurized. As described, the light-shielding member 15 in the present modification can be formed in another order different from that illustrated in FIG. 13.

Then, grooves 41 can be formed in the light-transmitting plate 40 ((3) in FIG. 15) through the light-shielding member 15 by any appropriate known method including a half-dicing using a dicer, a dry etching method, a blasting treatment, or the like. The grooves 41 can be formed in a circular shape or the like when viewed from above, corresponding to the shape of the light-emitting body 13. The grooves 41 can have a depth corresponding to at least the height of the light-emitting body 13 or more, for example, 100 μm to 400 μm, and a width of, for example, 50 μm to 500 μm. Thus, in this modification, the grooves 41 can penetrate the light-shielding member 15.

Then the grooves 41 can be filled with a phosphor to form the phosphor layer 31 ((4) in FIG. 15). In the present exemplary embodiment, the phosphor layer 31 can include a phosphor powder and a binder material. The raw material phosphor can be appropriately selected depending on the wavelength of the excitation light, the wavelength of emitted fluorescent light, etc. Examples of the phosphor used when a laser diode that emits light at a wavelength of around 450 nm is used as an excitation light source may include LuAG:Ce, YAG:Ce, CASN:Eu, and the like. These phosphors can be used alone or in combination of two or more in a desired mixing ratio to adjust its chromaticity. Examples of the binder material used may include various resin materials, such as an epoxy resin and a silicone resin, and low-melting point glass materials, such as a phosphate glass material.

After the phosphor layer 31 was formed, the entire light-transmitting plate 40 can be polished ((4) in FIG. 13) by any known polishing techniques to have a desired thickness.

Then, the light-transmitting plate 40 can be cut at positions outside the grooves corresponding to the respective light-emitting bodies 13 to obtain individual pieces of the light-emitting bodies 13 ((6) in FIG. 13) by any known techniques for cutting, such as a laser dicing or the like.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A light-emitting device comprising:
a light source configured to emit light for excitation; and
a light-emitting body configured to absorb excitation light to emit fluorescence light,
the light-emitting body including: a first light-transmitting member with a plate shape and having a first surface, a second surface opposite to the first surface, and an outer peripheral surface between the first surface and the second surface; a phosphor layer disposed on the outer peripheral surface of the first light-transmitting member; a second light transmitting member disposed on an outer peripheral surface of the phosphor layer; and a light-shielding member configured to cover the first surface, wherein
the light source is disposed such that the excitation light therefrom can be incident on the second surface, pass through the first light-transmitting member, and reach the phosphor layer.

2. The light-emitting device according to claim 1, wherein the light-shielding member covers the phosphor layer and the second light-transmitting member on the same side as the first surface.

3. The light-emitting device according to claim 1, wherein the phosphor layer is exposed on a side of the first surface, and the light-shielding member covers the first surface and the second light-transmitting member on the same side as the first surface.

4. A method of manufacturing a light-emitting body, comprising:
preparing a plate light-transmitting member having a first surface and a second surface opposite to the first surface;
determining shapes of individual pieces constituting the light-transmitting member;
forming a groove in the first surface so that the groove can have a similar shape as at least part of the shape of the individual piece;
filling the groove with a phosphor;
forming a light-shielding member on the first surface;
thinning the light-transmitting member; and
separating the light-transmitting member to make it to the individual pieces.

5. A light-emitting body comprising:
a first light-transmitting member with a plate shape having a top surface, a bottom surface opposite to the top surface, and an outer peripheral surface;
a phosphor layer disposed on the outer peripheral surface of the first light-transmitting member, the phosphor layer having an outer peripheral surface;
a second light-transmitting member disposed on the outer peripheral surface of the phosphor layer; and
a light-shielding member configured to cover the top surface of the first light-transmitting member.

6. The light-emitting body according to claim 5, wherein the phosphor layer is exposed between the first light-transmitting member and the second light-transmitting member, and the light-shielding member covers the top surface of the first light-transmitting member and a top surface of the second-light transmitting member.
